(19) United States
(12) Patent Application Publication
(10) Pub. No.: US 2015/0095085 A1
(43) Pub. Date: Apr. 2, 2015

(54) SYSTEM AND METHOD FOR DEALER NETWORK VISUALIZATION

(71) Applicant: Cox Digital Exchange, LLC, Atlanta, GA (US)

(72) Inventors: Michael Sweeney, Atlanta, GA (US); Paul David Sims, Atlanta, GA (US)

(21) Appl. No.: 14/501,876

(22) Filed: Sep. 30, 2014

Related U.S. Application Data
(60) Provisional application No. 61/884,963, filed on Sep. 30, 2013.

(51) Int. Cl. G06Q 10/06; G06Q 40/00; G06Q 50/00

(52) U.S. Cl. CPC G06Q 10/063118; G06Q 50/01; G06Q 40/12
USPC 705/7.17; 705/7.11

(57) ABSTRACT

Systems and methods are provided for dealer network visualization. A method may include receiving a user identifier associated with a user and accessing vehicle transaction history associated with the user identifier. The method may also include determining, based at least in part on the vehicle transaction history, one or more vehicle transactions associated with the user identifier. Furthermore, the method may include identifying one or more dealers associated with the one or more vehicle transactions. The method may also include generating a network visualization indicating respective dealer connections between the user and the one or more dealers and displaying the network visualization.

### CROSS-REFERENCE TO RELATED APPLICATIONS

This application claims the benefit of U.S. Provisional Application No. 61/884,963, filed Sep. 30, 2013, entitled “System and Method for Dealer Network Visualization,” the contents of which are hereby incorporated by reference.

### BACKGROUND

Dealers and/or other vehicle retailers often engage in vast amounts of vehicle transactions with other vehicle retailers, either directly or indirectly through intermediaries, such as vehicle auctions, other vehicle retailers, and/or the like. As such, a vehicle retailer may wish to use past transaction histories with other retailers to assess the quality of past transactions and various other information. To this end, the ability to visualize information associated with such past transaction histories may provide an effective tool for providing retailers a view of their transaction network and for identifying any preferred retailers.

### BRIEF DESCRIPTION OF THE DRAWINGS

FIG. 1 is a schematic block diagram of an illustrative architecture in accordance with one or more example embodiments.

FIG. 2 is a diagram of an example network visualization in accordance with one or more example embodiments.

FIG. 3 is a process flow diagram of an illustrative method for displaying a dealer network visualization in accordance with one or more example embodiments.

### DETAILED DESCRIPTION

### Overview

Embodiments of the present disclosure are directed to, among other things, providing a dealer network visualization platform that may include a graphical display of dealer connections between a user-dealer, using a service provided by a service provider, and one or more dealers. Such a graphical display have dealer connections may provide a user-dealer a snapshot of dealers with which the user-dealer has transacted with.

The platform may also include the ability to generate recommendations for one or more dealers for the user-dealer to interact with. For example, the platform may determine that the user-dealer has indirectly dealt with a dealer through an intermediary (e.g., an auction) in the past. As such, the platform may recommend that the user-dealer directly transact with the dealer in order to avoid going through the intermediary and avoid the costs associated therewith.

Additionally, dealers, buyers, and/or other users of the platform may create groups of other platform users to facilitate social and/or trusted networks for viewing and/or exchanging items listed in a seller's inventory. For example, one or more item inventories (each, possibly, from a different seller) may be received, scrubbed, indexed, or otherwise aggregated into a marketplace record of items and presented to buyers based on being associated with one or more buyer-defined groups. In some aspects, the buyers may view the items by way of a list, a grouping, an index, or other data structure presented on a display device of a buyer computer. Further, in some aspects, an exchange may include a direct sale (e.g., an exchange of the item for cash or its equivalent) or a trade (e.g., an exchange of the item, whether new or used, in full or partial satisfaction for another new or used item).

Additionally, in some examples, the platform may include inventory aggregation services, inventory and/or item listing services, messaging services, information exchanges, trusted dealer group services, item settlement services, item and/or dealer review services, backstopping services (e.g., guaranteed prices), and/or item exchange services in the form of offer, counter-offer, and/or price negotiation messaging. Further, by providing market information, retail pricing, preferred pricing, price backstopping, want ads, and the like, the platform may leverage dealer relationships to facilitate the buying and/or selling of items.

As an overview, items may be any products or services that may be sold or exchanged, for example, and without limitation, vehicles, computer products, firearms, articles of clothing, jewelry, consumer electronics, yard appliances, construction machines and equipment, aircraft, boats, office equipment, furniture, manufacturing equipment, packaging equipment, kitchen equipment, appliances, combinations of the foregoing, or the like, or related products and components. While many of the embodiments of this Detailed Description are described in terms of vehicles, those of skill in the art will understand that the disclosure is not so-limited, and other products, as described herein, could be substituted for vehicles.

In some examples, and as noted above, the platform may facilitate the sales and/or exchanges of vehicles between dealers. For example, the platform may aggregate all, or a subset of all, vehicles found in inventory at every dealer, or a subset of every dealer, within a geographic region (e.g., within various cities, counties, states/territories/provinces, the United States, or one or more other countries), a set of geographic regions, a dealer franchise, a dealer network, a group of friends, the world, etc. The vehicles and/or inventories may be received from the dealers, from dealership management systems (DMSs), or from one or more third-party services that store, collect, or otherwise manage dealer inventories. Additionally, buyers may form groups, networks, or other organizational methods for grouping dealers that the buyer knows, trusts, has worked with before, or with whom the buyer is otherwise affiliated. Thus, in some examples, a first dealer (e.g., a buyer) may create a group of trusted dealers to interact with (e.g., a second dealer whom the first dealer knows and trusts and/or a third or more dealers, whom the first dealer has worked with before). The first dealer may be able to rate or review the dealers within the group, view inventories of the dealers within the group, and add or remove dealers from the group, as well as send messages, post comments, provide purchase/exchange offers to, and/or receive purchase/exchange counter-offers from, dealers within the group.

In some examples, the platform may provide settlement services such as, but not limited to, title services, shipping services, arbitration services, financing services, payment transfer services, and the like, to the dealers (e.g., the buyer) once a purchase/exchange agreement occurs. Additionally, the platform may provide functionality for completing the purchase/exchange. However, in some examples, the platform may facilitate communication between the trading parties and may not actually be involved in the transaction between the dealers. In this way, the platform may allow the dealers to communicate and/or consummate transactions outside of the platform. However, in this case, the platform may request that the dealers provide transaction information to the platform once the transaction is complete. That way, the platform may be able to update the inventory record to indicate that a vehicle has moved from one dealer's inventory to another's.

As noted above, in some examples, dealers using the platform may rate and/or review other dealers. Additionally, dealers may rate and/or review groups they have created and/or groups of which they are members. However, in some examples, the platform may generate a score or rating for the dealers and/or groups instead of, or in addition to, the user-provided ratings. For example, a dealer or group rating may be based on satisfaction of other dealers (e.g., the user-provided ratings), a number of transactions completed by the dealer or group, a number of groups within which a dealer is a member, a number of links provided by a dealer or group, or a number of links followed by a dealer or a group.

In some aspects, the platform may receive or determine wholesale, retail, and/or other values for each vehicle in the aggregated record. In some examples, a wholesale and/or retail value may be provided by the seller, a DMS service, a third-party vehicle valuation service, or it may be determined by the platform. For example, the value may be based on the condition of the vehicle, the year, the make and/or model of the vehicle, and/or market conditions, such as real-time market conditions, related to similar vehicles. By way of example and without limitation, real-time market conditions may include conditions that are determined based on real-time, or near real-time, data. That is, data may be updated continuously over a period of time such as, but not limited to, every second, every minute, every hour, every day, every week, etc., or any appropriate interval based on the context. For example, and as those of skill in the art will understand, different contexts may create different understandings of real-time (e.g., in the new and/or used automobile market, real-time market conditions may imply market conditions that change throughout a day or even a week). In other aspects, however, the value may be determined, like a listing price, by the seller.

In some examples, item sellers may be item owners who wish to sell or exchange their items, or those with the authority to sell or exchange the items for the owners. Additionally, item buyers may be those people or entities that receive items, new or used, in exchange for either money (or its equivalent) or other items. Generally, but not always, the item buyer may intend, or attempt, to resell the item that was received.

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

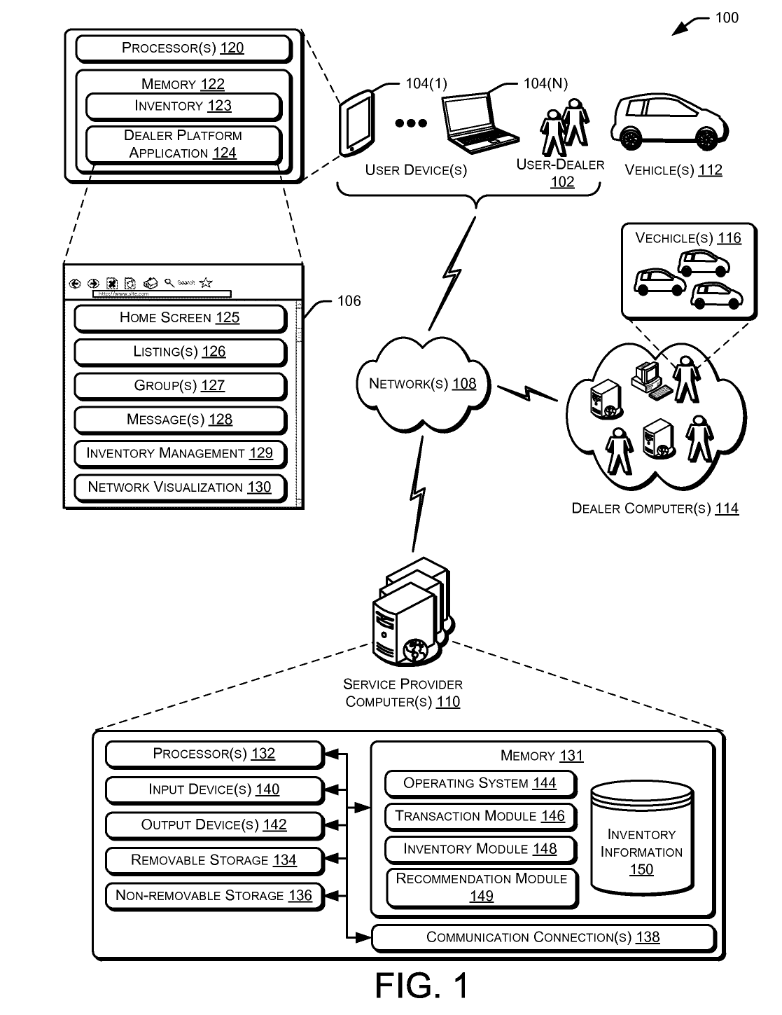

FIG. 1 depicts an illustrative architecture 100 in which techniques for a dealer network transaction platform may be implemented. In architecture 100, one or more users 102 may utilize computing devices 104(1), . . . , 104(N) to access a client application interface (or website) 106 that may be provided by, created by, or otherwise associated with a service provider via one or more networks 108. In some instances, the computing devices (collectively 104) may be configured to present or otherwise display the client application interface 106 to the one or more users 102. The networks 108 may include any one or a combination of multiple different types of networks, such as cable networks, the Internet, wireless networks, and other private and/or public networks. While the illustrated example represents users 102 (e.g., a dealer) accessing the client application interface 106 over the networks 108, the described techniques may equally apply in instances where the users 102 interact with a service provider via a personal computer, over the phone, via a kiosk, or in any other manner. It is also noted that the described techniques may apply in other client/server arrangements (e.g., set-top boxes, etc.), as well as in non-client/server arrangements (e.g., locally stored software applications, etc.).

In some implementations, the client application interface 106 may allow the users 102 to access, receive from, transmit to, or otherwise interact with the service provider via one or more service provider computers 110. In some examples, the client application interface 106 may also enable users to receive, from the service provider computers 110 over the networks 108, information associated with one or more vehicles 112 in an inventory of a user 102 including, but not limited to, the make, the model, the color, the mileage, the vehicle identification number (VIN), condition, trim, etc. Through the client application interface 106, the user 102 may provide information associated with a vehicle 112 that the user 102 would like to sell or exchange. Additionally, through the client application interface 106, the user 102 may also provide information associated with a vehicle 112 that resides on the user's 102 lot, regardless of whether it is currently for sale or not. Further, in some examples, information about vehicles 112 that are in a user's 102 inventory may be provided to the service provider computers 110 by third-party providers such as, but not limited to, DMSs, other inventory management systems, or other inventory data feeds.

The service provider computers 110 may be any type of computing devices such as, but not limited to, mobile, desktop, kiosk, and/or cloud computing devices, such as servers. In some examples, the service provider computers 110 may be in communication with the user devices 104 via the networks 108, or via other network connections. The service provider computers 110 may include one or more servers, perhaps arranged in a cluster, as a server farm, or as individual servers not associated with one another. These servers may be configured to host a website viewable via the client application interface 106 or any other Web browser accessible by a user 102 such as, but not limited to, one or more of the user devices 104.

The architecture 100 may also include one or more vehicle dealers operating one or more dealer computing devices 114 and/or selling (or trading) one or more vehicles 116, such as at a used and/or new car lot. The dealer computing devices 114 may also be any type of computing devices, such as but not limited to, mobile, desktop, kiosk, and/or cloud computing devices, such as servers. In some examples, the dealer computers 114 may be in communication with the service provider computers 110 and/or the user devices 104 via the networks 108, or via other network connections. In some examples, the dealer computer 114 may be one or more user devices 104. As such, it will be understood by those of ordinary skill in the art that the user 102 may be a dealer 114. The dealer computers 114 may include one or more servers, perhaps arranged in a cluster, as a server farm, or as individual servers not associated with one another. These servers may be configured to provide information associated with the vehicles 116 to the service provider computers 110 and/or to one or more third-party inventory aggregators such as, but not limited to, a DMS or other inventory management service provider.

The user devices 104 may be any type of computing devices including, but not limited to, desktop personal computers (PCs), laptop PCs, mobile phones, smart phones, personal digital assistants (PDAs), tablets PCs, game consoles, set-top boxes, wearable computers, e-readers, web-enabled TVs, cloud-enabled devices and work stations, and the like. In some instances and as illustrated, each user device 104 may be equipped with one or more processors 120 and memory 122 to store applications and data, such as inventory 123 and/or a dealer network application 124 that may display the client application interface 106 and/or enable access to the Web site 106 stored on the service provider computers 110, or elsewhere.

In some aspects, the client application interface 106 may display a home screen 125 for interacting with the dealer network application 124. Additionally, the interface 106 may provide functionality for vehicle listings 126, dealer groups 127, and/or user messages 128. Further, the interface 106 may provide inventory management 129 capabilities and/or the ability for users 102 to provide, rate, and/or review advertisements 130. In some aspects, the home screen 125 may provide links and/or images for allowing users 102 to interact with and/or operate the dealer network application 124. The vehicle listings 126 functionality may provide users 102 with the ability to view, rank, and/or filter vehicle listings. For example, a user 102 may use the listings 126 functionality to request to view a listing of a particular type of vehicle in an inventory within a certain price range, distance from the user 102, and/or in an inventory of a dealer within a particular group. The groups 127 functionality may provide a user 102 with the ability to create groups of one or more dealers 114. For example, users 102 may create groups of trusted dealers, groups of dealers within a certain geographic region, groups of dealers that sell/trade a particular brand of vehicle, etc.

The messages 128 functionality may provide a user 102 with the ability to post or send messages to other users 102 (e.g., dealers 114), group members, or a bulletin board. In some examples, a user 102 may be able to send an email, a text message, a voice message, an instant message (IM), or any other type of message that may be sent to another user device 104 or a dealer computer 114. The messages 128 may provide functionality for general communication between users 102 and/or dealers 114, for making offers and/or counter-offers, and/or for leaving reviews and/or ratings of other users 102, dealers 114, groups, etc. In some examples, the messages 128 may be provided as pop-up messages. The inventory management tool 129 may, in some examples, allow a user 102 and/or a dealer 114 to update, view, and/or provide an inventory of vehicles available for purchase.

Further, the network visualization tool 130 may be configured to enable a user to view (e.g., via a home screen 125, on a listing screen 126, or on any other page of the interface 106) one or more dealer connections to other users and/or dealers. For example, a dealer connection may be created between two dealers if a vehicle transaction occurs between the two dealers (e.g., buying and/or selling a vehicle). In other implementations, a dealer connection may be created between two dealers even if they do not directly transact with one another. For instance, a first dealer may sell a vehicle at a vehicle auction, and a second dealer may purchase that dealer from the vehicle auction. Though the first dealer and the second may not directly transaction or communicate with each other, a dealer connection may still be created between the first dealer and the second dealer. Such a dealer connection may be visualized by the network visualization tool 130 (e.g., for the first dealer and/or the second dealer) such as in the form of a graph, tree structure, and/or any other type of illustration. The creation of dealer connections is described in more detail below with respect to the service provider computer(s) 110.

In some aspects, one or more servers, perhaps arranged in a cluster or as a server farm, may host the service provider 110. Other server architectures may also be used to host the service provider 110. The service provider computers 110 are capable of handling requests from many users 102 and serving, in response, various listings, messages, advertisements, and/or user interfaces that can be rendered at user devices 104.

In one illustrative configuration, the service provider computer 110 comprises at least a memory 131 and one or more processing units (or processor(s)) 132. The processor(s) 132 may be implemented as appropriate in hardware, software, firmware, or combinations thereof. Software or firmware implementations of the processor(s) 132 may include computer-executable or machine-executable instructions written in any suitable programming language to perform the various functions described. The computer processors 132 may comprise one or more cores and may be configured to access and execute (at least in part) computer-readable instructions stored in the memory 131. The one or more computer processors 132 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The service provider computer(s) 110 may also include a chipset (not shown) for controlling communications between the one or more processors 132 and one or more of the other components of the service provider computer(s) 110. In certain embodiments, the service provider computer(s) 110 may be based on an Intel® architecture or an ARM® architecture, and the processor(s) and chipset may be from a family of Intel® processors and chipsets. The one or more processors 132 may also include one or more application-specific integrated circuits (ASICs) or application-specific standard products (ASSPs) for handling specific data processing functions or tasks

Memory 131 may store program instructions that are loadable and executable on the processor(s) 132, as well as data generated during the execution of these programs. Depending on the configuration and type of service provider computer 110, memory 131 may be volatile (such as random access memory (RAM)) and/or non-volatile (such as read-only memory (ROM), flash memory, etc.). The service provider computer 110 or server may also include additional removable storage 134 and/or non-removable storage 136 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 131 may include multiple different types of memory, such as static random access memory (SRAM), dynamic random access memory (DRAM), or ROM.

The memory 131, the removable storage 134, and the non-removable storage 136 are all examples of computer-readable storage media. For example, computer-readable storage media may include volatile and non-volatile, removable and non-removable media implemented in any method or technology for storage of information such as computer-readable instructions, data structures, program modules, or other data. Memory 131, removable storage 134, and non-removable storage 136 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the service provider computer 110 or other computing devices. Combinations of the any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computer 110 may also contain communication connection(s) 138 that allow the service provider computer 110 to communicate with a stored database, another computing device or server, user terminals, and/or other devices on a network. The service provider computer 110 may also include input device(s) 140 such as a keyboard, mouse, pen, voice input device, touch input device, etc., and output device(s) 142, such as a display, speakers, printers, etc.

Turning to the contents of the memory 131 in more detail, the memory 131 may include an operating system 144 and one or more application programs or services for implementing the features disclosed herein including a transaction module 146, an inventory module 148, and/or an inventory information datastore 150. Broadly, the transaction module 146 may be configured to receive, store, create, and/or determine dealer connections between one or more user-dealers 102 and/or dealers of the dealer computer(s) 114.

The inventory module 148 may be configured to receive, store, and manage inventory information from licensed dealers. For example, the inventory module 148 may pull, request, scrub, mine, or otherwise collect vehicle inventory information from one or more of the dealer computers 114, the user devices 104 (e.g., inventory 123), a DMS, and/or a data feed. In some aspects, the inventory information may include a VIN number, a make, a model, a year, a condition, a color, a trim, a value, a mileage, an image, a recording, a video, a location, a seller, an inventory identifier, an amount of time the vehicle has been in a particular inventory, and/or an amount of time the vehicle has been available for exchange, trade, and/or sale. The collected inventory information may be stored in the inventory information datastore 150. As such, the inventory information datastore 150 may store information associated with one or more vehicles 112 or 116 that are found in one or more inventories of the users 102 and/or the dealers 114. For example, the inventory information datastore 150 may include information associated with every vehicle in a first inventory and every vehicle in a second inventory, each inventory associated with a different user 102 or the dealer 114. Further, the inventory information datastore 150 may be configured to store an index, a chart, a table, or other data structure for associating particular vehicle information with each vehicle stored in the datastore 150.

In some aspects, the transaction module 146 may be configured to receive information associated with one or more vehicles in an inventory of one or more dealer computers 114, or affiliates of the dealer computers 114. The vehicle information may be received from the first dealer computer 114, from an affiliate or associate, from a DMS, or from a third-party inventory management system or a data feed. The transaction module 146 may then receive, from a user dealer (e.g., the user 102, an affiliate of the user 102, or an associate of the user 102), an indication of a relationship with the first dealer. In some aspects, the indication of a relationship may involve inclusion in a group of dealers. The group may be defined by the user dealer or may be based on the vehicles' location, type, make, model, color, etc. (in other words, certain groups may be system generated).

Further, in some aspects, the transaction module 146 may receive, from the user-dealer 102, a request to view the information associated with the one or more vehicles. The transaction module 146 may then determine whether the user dealer is a member of the system/platform or a non-member viewer. In some examples, when the user dealer is a member, the transaction module 146 may then determine a rating of the first dealer or a level of trust between the first dealer and the user dealer based on the indication of the relationship or the aggregated score. Finally, the transaction module 146 may provide, to the user dealer, the information associated with the one or more vehicles in the inventory of the first dealer based on the determined level of trust or the determined rating. However, in some examples, instead of the vehicle information being obtained or otherwise coming from just a first dealer, the transaction module 146 may provide the above services utilizing vehicles and/or vehicle information aggregated by the inventory module 148 from multiple dealers. Alternatively, if the user dealer is not a member, the transaction module 146 may display a more limited set of vehicle information. For example, the transaction module 146 may only show a vehicle picture or a vehicle price to non-members, while the transaction module 146 may display the dealer (e.g., the seller) of the vehicle, as well as other vehicle information and/or functionality for communicating with the seller.

In some examples, the transaction module 146 may also be configured to determine when the first dealer is a member of the system and appropriately provide additional information to the user dealer based on this determination. For example, the user dealer may only see portions of vehicle information when the information is associated with a non-member. However, in some examples, the user dealer may be provided with additional non-member vehicle information after providing a membership invitation to the non-member, after the non-member accepts a membership invitation, and/or after the non-member joins. For example, a list of vehicles matching a search query may be provided to the user dealer. In some examples, all vehicle information (including dealer information) may be provided in the list next to vehicles associated with member inventories while only a limited amount of vehicle information may be provided next to vehicles associated with non-member inventories. In order to view the dealer of the vehicle, the location of the vehicle, etc., the user dealer may be prompted to invite the dealer to join. Once the invitation is sent or accepted, more vehicle information associated with the non-member dealer may be provided to the user dealer.

As noted above, in some aspects, the transaction module 146 may receive inventory information from the dealer computers 114, from the user devices 104, or from a DMS or data feed. However, in other examples, the transaction module 146 may receive inventory information from a retail vehicle exchange service, a wholesale vehicle exchange service, a commercial vehicle exchange service, a financial institution, or a vehicle listing service. Additionally, a price or value of the vehicle may be received with the information, stored, and/or provided to a user 102. Thus, the price and/or value may depend on the type of service from which the information was received. For example, if the inventory information is received from a retail exchange service, the price and/or value may be a retail value assigned to the vehicle. However, in other examples, the price and/or value of the vehicle may be independent of the information source, determined by the transaction module 146 based on market information for similar vehicles, based on a value provided by a third-party, based on a wholesale value, based on a range of values associated with a relationship between the user and the dealer (e.g., when the dealer is in a user-created group), and/or based on a determined level of trust (e.g., when the dealer is trusted by the user 102).

In some instances, the transaction module 146 may provide functionality to allow a user 102 to create groups, huddles, networks, or other organizational structures for associating one or more dealers together. For example, a user 102 may create a trusted group and include one or more trusted dealers in the group. Additionally, a user 102 may create a group of dealers within a geographic region, a group of dealers that sell a particular make or model, a group of dealers that are part of a buying group, etc. In some examples, a user interface may be provided to the user 102 to create groups and/or assign dealers (e.g., other users 102) to groups. In some examples, when a list of vehicles in inventory is created for a user 102, generally, in response to an inventory query, the transaction module 146 may present the group name, label, or indicator that may signify the group with which this particular dealer is affiliated. The name, label, or indicator may be presented next to, alongside of, or adjacent to the vehicle information. Additionally, once a group is created, and members are assigned to the group, the transaction module 146 may receive, from the user 102, attributes for the group. In some aspects, the attributes may include a trust level, a user-generated rating, a group score, an aggregated score, and/or an activity score. Further, this score may be presented as an image, icon, moving image, moving icon, or the like. For example, a dynamic gas meter may be displayed next to a vehicle or the vehicle information to indicate the rating, score, trust level, etc. (e.g., when the needle is higher on the meter, the rating and/or score will be higher and/or different colors may indicate lower or higher scores, levels, and/or ratings. Further, dealers 114 may be able to provide group rates that are specific to certain groups. For example, a particular car may be listed by the dealer 114 at a first price for a trusted group and at a higher price for a different group.

In some examples, the transaction module 146 may be configured to provide functionality for users 102 to rate and/or review other users (e.g., dealers). Additionally, key words may be mined from the reviews to generate more quantitative ratings and/or scores. This user rating may be a part, in some examples, of the aggregated score mentioned above. For example, an aggregated score (or a “thumb score” signified by a “thumb” icon) may be generated based at least in part on the user rating. For example, if a dealer gets a “thumbs up” rating from a user 102, this may increase its “thumb score” (i.e., aggregated score), while a “thumbs down” rating may decrease its “thumb score.” Other factors that may be included in a “thumb score” include, but are not limited to, vehicle ratings associated with the dealer, transaction ratings (e.g., ratings and/or reviews directed at a completed or attempted transaction such as, but not limited to, selling or trading a vehicle), activity scores (e.g., how much activity occurs on the dealer's account or behalf), a number of transactions conducted or completed, a number of positive or negative comments provided or received, a number of hyperlinks provided, a number of hyperlinks visited, a number of groups created, a number of groups included in the transaction module 146, and/or a value provided to the group. Additionally, in some aspects, the thumb score may be provided or presented next to the vehicle information via the interface 106.

Additionally, a user 102 may initiate, provide, or request that messages be transmitted to other members. In some examples, messages may only be sent to members; however, in other examples, non-members may receive messages either with limited functionality or after an invitation to join is sent or accepted. In some examples, an interface such as, but not limited to, messages 128 of interface 106 may be configured to facilitate preparing and/or transmitting, to a user 102, an email, a text message, an instant message, a voice message, a video message, a telephone call, a video call, or any other source or method of communication. By way of example, a message may include an offer price, a counter-offer price, a request for settlement, and/or a question about the vehicle. Further, in some examples, a user 102 may create a note or other comment thread that only the user 102 can review.

According to certain embodiments, the inventory information datastore 150 may also include vehicle transaction histories associated with the one or more vehicles 112/116. A vehicle transaction history for a particular vehicle may include information identifying one or more dealers who possessed the vehicle in their respective inventories at different points in time. The vehicle transaction history may also include information indicating the types of transactions that may have occurred to transfer the vehicle to various different dealers (e.g., buying, selling, etc.). Thus, the transaction module 146 may be configured to access a vehicle transaction history for a particular vehicle to determine a path of ownership (e.g., among user-dealers 102 and/or dealers of the dealer computer(s) 114) for the vehicle. As a result, the transaction module 146 may be able to track and/or otherwise determine, for a user-dealer 102, a number of transactions that have occurred between the user-dealer 102 and one or more dealers of the dealer computer(s) 114.

For instance, the transaction module 146 may access the inventory information datastore 150 to determine one or more vehicle transaction histories associated with one or more vehicles 112/116. Based at least in part on the vehicle transactions histories, the transaction module 146 may identify vehicles that are currently included, and/or were previously included, in the user-dealer's 102 inventory 123. The transaction module 146 may further determine, based at least in part on the vehicle transactions histories of the identified vehicles, a path of ownership for the identified vehicles (e.g., chain of title and/or other types of ownership information). The path of ownership may indicate one or more owners of the identified vehicles at various points in time and how the identified vehicles were transferred between the owners. For example, the path of ownership may indicate from which of the dealers of the dealer computer(s) 114 the user-dealer 102 acquired the identified vehicles. Furthermore, the path of ownership may indicate any transactions that occurred between an initial owner(s) of the identified vehicles, an intervening owners, and/or the user-dealer 102 up until the transaction in which the user-dealer 102 finally acquired the identified vehicles. Alternatively, and/or additionally, the path of ownership may also indicate the dealer(s) of the dealer computer(s) 114 that subsequently acquired the identified vehicles from the user-dealer 102, either from a direct transaction with the user-dealer 102 and/or after one or more intervening transactions between other dealers. To this end, for each dealer that the transaction module 146 may identify as having transacted with the user-dealer 102, either directly or indirectly through one or more intervening transactions, the transaction module 146 may create, generated, and/or otherwise indicate a dealer connection between the user-dealer 102 and the identified dealer. Such dealer connections may be reflected in the network visualization 130 provided by the dealer platform application 124 at the user-dealer's 102 direction.

Referring back to the dealer platform application 124, in some examples, the dealer platform application 124 may enable a user-dealer 102 to customize the network visualization 130 according to one or more dealer connection parameters (hereinafter referred to as parameters). Such parameters may allow the user dealer 102 to specify the types of dealer connections to be displayed by the network visualization 130. For example, the dealer platform application 124 may provide the user-dealer 102 an option to select the minimum and/or maximum number of intervening transactions, between the user-dealer 102 and a hypothetical dealer, in order for a dealer connection to be generated/created (and subsequently displayed) between the user-dealer 102 and hypothetical dealer. Another parameter may enable the user-dealer 102 to select the display of dealer connections between the user-dealer 102 and other dealers that are within a particular geographic location and/or distance from the user-dealer 102. Yet another parameter may enable the user-dealer 102 to select the display of dealer connections with other dealers that buy, sell, and/or are otherwise associated with vehicles of a particular make, model, year, and/or the like. Another parameter may enable the user-dealer 102 to select the display of dealer connections with other dealers that are members of a certain group. Another parameter may enable the user-dealer 102 to select the display of dealer connections with other dealers based upon a number of times the user-dealer 102 has transacted with the dealers (e.g., bought, sold, leased a vehicle, etc.). It will be appreciated that various other parameters associated with selection which dealer connections to display for the user-dealer 102 are also contemplated. According to some implementations, once the user-dealer 102 has selected the parameters, the parameters may be transmitted to the transaction module 146. As such, the transaction module 146 may filter the dealer connections (e.g., between the user-dealer 102 and any identified dealers) according to the parameters. The transaction module 146 may transmit the filtered dealer connections back to the dealer platform application 124, which may be configured to display the filtered dealer connection, such as via the network visualization 130.

The memory 131 may also include a recommendation module 149. The recommendation module 149 may be configured to generate one or more recommendations for the user-dealer 102 to engage in transactions with one or more dealers (e.g., dealers of the dealer computer(s) 114). Such recommendations may be based at least in part on the vehicle transactions histories stored in the inventory information datastore 150, which may indicate one or more dealer connections between the user-dealer 102 and certain dealers. For example, the transaction module 146 may determine that the user-dealer 102 has transacted with a first dealer a certain number of times, though indirectly (e.g., intervening transactions such as if the first dealer typically buys, at auction, vehicles that the user-dealer 102 puts up at the auction and/or vice-versa). The number may indicate a relatively high frequency of indirect transactions between the user-dealer 102 and the first dealer. For instance, the recommendation module 149 may determine that a number of indirect transactions between the user-dealer 102 and the first dealer is greater than or equal to a number threshold. Thus, the recommendation module 149 may receive such an indication, and generate one or more recommendations for the user-dealer 102 to transact with the first dealer. It will be appreciated that recommendations may be based on other factors as well, such as membership with a certain group or groups, geographical location, vehicle types, and/or the like. For example, if the user-dealer 102 and the first dealer reside in a similar geographic location, the recommendation module 149 may be more likely to recommend that the user-dealer 102 and the first dealer transact with each other.

In certain embodiments, the dealer platform application 124 may also be configured to facilitate searches for vehicles 112/116 and/or information associated with such vehicles 112/116. For example, a user-dealer 102 may enter a search query into a search field provided by the transaction module 146 to request a list of vehicles from the aggregated information that matches the search query. In response to the search request, the transaction module 146 may conduct a search of the aggregated information and return a list of vehicles with associated vehicle information, icons (e.g., a “thumb score,” a meter, a group indicator, etc.), and/or vehicle values. Further, the transaction module 146 may also be configured to receive a filter and/or a ranking parameter for filtering and/or ranking the search results. For example, a filter parameter or a ranking parameter may include a network, a group, a dealer identifier, an associate identifier, a trust level, a relationship, a vehicle type, a vehicle make, a vehicle model, a vehicle color, a vehicle mileage, and/or a vehicle condition. That is, the search results may be refined, filtered, and/or ranked based on any one or a combination of these parameters. Additionally, in some examples, the filtering and/or ranking parameters may be weighted such that some parameters have more influence on the filtering and/or ranking.

As noted above, a list of search results may include an indication of the group that the vehicle belongs to (if any). In some aspects, next to or associated with the search results, the transaction module 146 may also present an indication of how long the vehicle has been in inventory. The indication may be a number (e.g., a number of days) or it may be an icon that represents time in some way such as, but not limited to, an icon, a color, an image, a video, a chart, or a graph. Alternatively, or in addition, the indication of how long the vehicle has been in inventory may, by way of example, only be displayed once the length of time has passed beyond a predefined time. Additionally, each predefined time period may be defined by the members of a group. Further, in some examples, proxy bids and/or offers may be placed on vehicles by users 102 even when not logged in. In some aspects, the proxy offer may be placed on vehicles that drop below a certain price, are listed longer than the predetermined time, or are listed for longer than some other predefined time.

In some examples, the transaction module 146 may also be configured to receive and/or provide want-ads to members. That is, a user 102 who is in the market to purchase a vehicle from another dealer 114 may create a want-ad describing the type of vehicle the user 102 is looking for. This want-ad may then be placed on the interface of other users 102 and/or dealers 114 when they access the platform. The want-ads may be transmitted via email, text message, bulletin board post, pop-up message, or any combination thereof. Additionally, the transaction module 146 may be configured to receive preferences from the users 102. For example, a user 102 may set preferences including those directed to preferred dealers, preferred groups of dealers, preferred vehicles, preferred vehicle types, preferred communication settings, preferred viewing settings, and/or preferred settlement settings. Further, in some examples, the transaction module 146 may be configured to provide a guarantee price to a buyer. The guarantee price may be calculated by the transaction module 146 based on market information or it may be provided by a third-party service provider. In some examples, the service provider 110 may guarantee, underwrite, or otherwise insure the purchase between the user 102 and a dealer 114 selling a vehicle.

In some examples, the transaction module 146 may also be configured to receive third-party advertisements from sellers, dealers, service providers, or the like. For example, a third-party transportation service may provide advertisements to vehicle buyers and sellers in the form of contextual, pop-up, banner, text, and/or rich media advertisements. Additionally, the providers of the third-party advertisements may set preferences and/or request that the provided advertisements be placed and/or viewed throughout the interface 106 based on the service provided, the location of the vehicles being viewed, the types of the vehicles being viewed, preferred provider networks, etc. For example, a German body shop may select, prefer, request, or even pay a premium to have an advertisement placed next to a list of German vehicles that are for sale. In some aspects, dealers may be able to set preferences regarding which third-party service advertisements they prefer to be presented near, on the same page, or at the same time as vehicles they are offering for sale. Additionally, in some aspects, users 102 and/or dealers may be able to rate the third-party service providers using a rating system that may include “thumbs-up,” comments, stars, etc. For example, next to each third-party advertisement, one or more comments and/or a star, “thumb,” or other rating scale may be visible. Further, in some examples, a portion of the advertisement may include a button, icon, or other selector for viewing the ratings and/or comments provided by users 102 and/or dealers.

Further, in some examples, the transaction module 146 may also be configured to provide one or more vehicle tickers such as, but not limited to, a scrolling “new car” ticker, a scrolling “hot car” ticker, combinations of the foregoing, or the like. For example, a streaming and/or scrolling ticker may be placed on the top, bottom, or other portion of the interface 106 to display vehicles and/or hyperlinks to detail and/or listing pages of vehicles that have recently been added to inventory at one or more dealer's lots. As mentioned, the ticker may include hyperlinks to detail and/or listing pages; however, the ticker may also include images, prices, and/or other information. Additionally, in some examples, a “hot car” ticker may be provided that displays hyperlinks, images, information, prices, etc. of vehicles that been determined or otherwise indicated as being popular, highly sought after, or otherwise in demand. For example, vehicles that have been purchased, traded, and/or viewed a number of times above a predefined threshold may be displayed in the “hot cars” ticker. Further, in some examples, the “new car” and “hot car” tickers may be combined to a single ticker. In this case, some identifier may be applied to the ticker to indicate which vehicles are “new” and which vehicles are “hot.” For example, “hot” cars may be a different color or may be identified with flames around or near the hyperlink, image, text, etc. In some aspects, the users 102 may be able set preferences regarding what vehicles and/or information should be provided (if at all) in the one or more tickers. For example, the users 102 may turn off the tickers, set the location, number, color, size, etc. of the tickers, and/or determine what vehicles should be included in the tickers. For example, a user 102 may prefer, and thus set the preferences, to have the ticker(s) display “new” and/or “hot” vehicles of a particular price, location, make, model, dealer, color, etc. Additionally, the user 102 may be able to set preferences for determining what and/or how cars are classified “new” and/or “hot.”

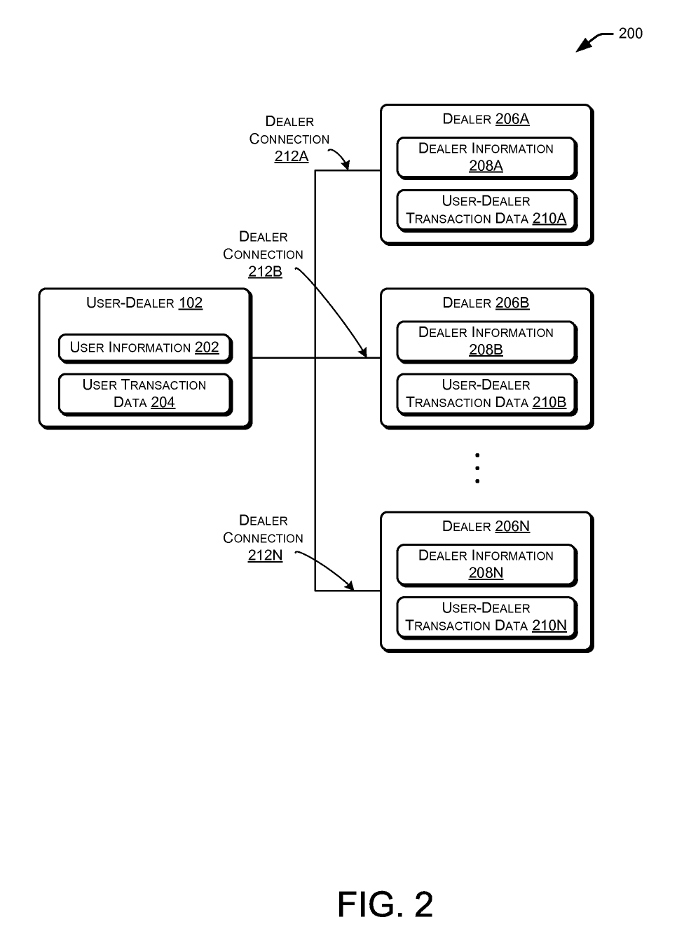

FIG. 2 depicts a block diagram of a network visualization 200 for a user-dealer 102 in accordance with one or more example embodiments. The block diagram may depict the types of information that may be displayed by the network visualization. As illustrated in FIG. 2, the network visualization 200 may be associated with the user-dealer 102 and may include one or more dealer connections 212A-N between the user-dealer 102 and dealers 206A-N. The network visualization 200 may display user information 202 and user transaction data 204 associated with the user-dealer 102. In certain implementations, the user information 202 may include information identifying the user-dealer 102, such as a company name, geographical location, and/or the like. The user transaction data 204 may include information associated with transactions that the user-dealer 102 has participated in, such as buying vehicle, selling vehicles, and other types of vehicle transactions. In some instances, the user transaction data 204 may include a number of transactions in which the user-dealer 102 has participated.

The network visualization 200 may also display dealer information 208A-N and user-dealer transaction data 210A-N for dealers 206A-N that are associated with a dealer connection with the user-dealer 102. The dealer information 208A-N may include information identifying the dealers 206A-N such as name, company name, geographical location, contact information (e.g., phone number, address, email, etc.) and/or the like. The user-dealer transaction information 210A-N may include information related to transactions that have occurred between the user-dealer 102 and dealers 206A-N. In certain instances, such transactions may be further identified as a direct transaction and/or an indirect transaction (e.g., there were intervening transactions. According to other implementations, the user-dealer transaction data 210A-N may also indicate a number of transactions performed between the user-dealer 102 and the dealers 206A-N and may also distinguish the types of transactions (e.g., buying, selling, leasing, etc.).

According to certain embodiments, the dealer connections 212A-N may be color coded (e.g., the lines representing the dealer connections 212A-N may be colored) according to whether respective dealers 206A-N are members of certain groups of a particular group type. Various types of group types are possible are contemplated. For instance, an example group type may be service subscription group type in which dealer connections 212A-N may be grouped according to different subscribed services, such as from a service provider. For example, dealer connections 212A-N in which the respective dealers 206A-N are subscribed to a first service may be colored by a first color, and dealer connection 212A-N in which the respective dealers 206A-N are subscribed to a second service may be colored by a second color. Furthermore, color coding may be applied to other ways of grouping dealer connections 212A-N, such as by geographic location (e.g., dealer connections 212A-N associated with dealers from different geographic locations may be colored with different colors), vehicle information associated with respective transactions, different intermediaries (e.g., auctions and/or other entities) used to transact with the respective dealers, and/or the like.

Various instructions, methods and techniques described herein may be considered in the general context of computer-executable instructions, such as program modules, executed by one or more computers or other devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example architectures and computing devices shown in FIGS. 1 and 2 are provided by way of example only. Numerous other operating environments, system architectures, and device configurations are possible. Accordingly, embodiments of the present disclosure should not be construed as being limited to any particular operating environment, system architecture, or device configuration.

### Illustrative Processes

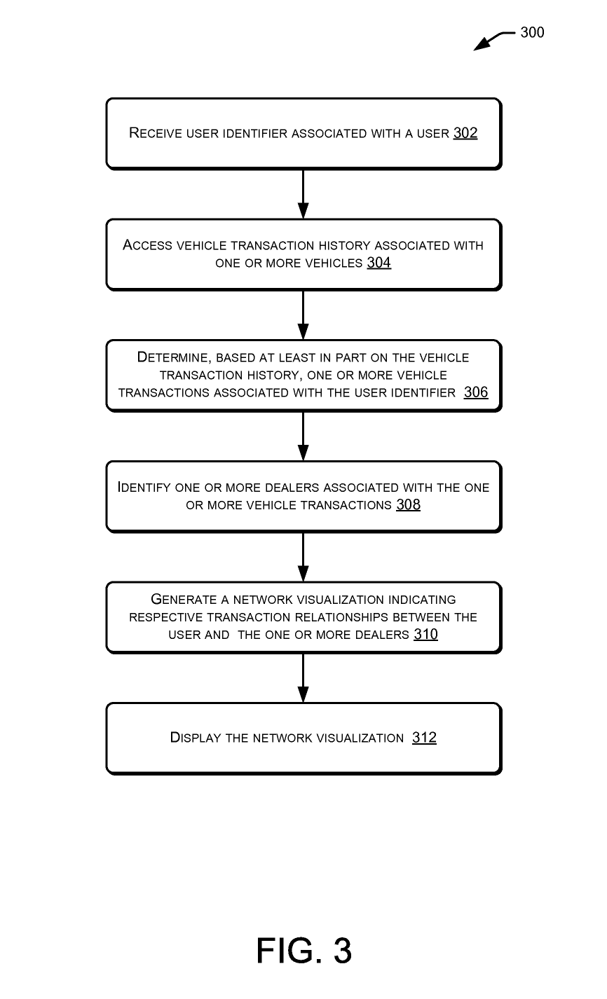

FIG. 3 illustrates an example flow diagram showing a method 300, for providing a dealer network visualization in accordance with one or more example embodiments. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The method 300 may, but need not, be implemented by a computing device operated by a service provider, such as the service provider computer 110. In some implementations, the method 300 may begin by receiving a user identifier associated with a user in block 302. Block 304 may include accessing vehicle transaction history associated with one or more vehicles. Furthermore, the method 300 may include determining, based at least in part on the vehicle transaction history, one or more vehicle transactions associated with the user identifier in block 306. In block 308, the method 300 may include identifying one or more dealers associated with the one or more vehicle transactions. The method 300 may further include generating a network visualization indicating respective transaction relationships between the user and the one or more dealers in block 310. In block 312, the method 300 may include displaying the network visualization.

Illustrative methods and systems for providing a dealer network visualization platform are described above. Some or all of these systems and methods may, but need not, be implemented at least partially by architectures such as those shown in FIGS. 1 and 2 above.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

That which is claimed:

1. A system, comprising:
at least one processor; and
at least one memory storing computer-executable instructions that when accessed by the at least one processor, causes the at least on processor to:
receive a user identifier associated with a user;
access vehicle transaction history associated with the user identifier;
determine, based at least in part on the vehicle transaction history, one or more vehicle transactions associated with the user identifier;
identify one or more dealers associated with the one or more vehicle transactions;
generate a network visualization indicating respective dealer connections between the user and the one or more dealers; and
display the network visualization.

2. The system of claim 1, wherein the computer-executable instructions further cause the at least one processor to:
generate a recommendation for the user to transact with a respective dealer of the one or more dealers, wherein the recommendation is based at least in part on a number of past transactions between the user and the respective dealer.

3. The system of claim 1, wherein the computer-executable instructions further cause the at least one processor to:
determine that a number of indirect transactions between the user and a respective dealer of the one or more dealers is greater than or equal to a number threshold; and
generate a recommendation for the user to directly transact with the respective dealer.

4. The system of claim 1, wherein the computer-executable instructions further cause the at least one processor to:
receive, from the user, one or more dealer connection parameters; and
display the network visualization according to the one or more dealer connection parameters.

5. The system of claim 4, wherein the one or more dealer connection parameters comprise information associated with at least one of a geographical location, a number of intervening transactions, a membership, or a vehicle.

6. The system of claim 1, wherein the computer-executable instructions further cause the at least one processor to:
determine a first group type associated with a first dealer of the one or more dealers and a second group type associated with a second dealer of the one or more dealer, wherein:
the first dealer is associated with a first dealer connection of the respective dealer connections with the user, and
the second dealer is associated with a second dealer connection of the respective dealer connections with the user; and
display, in the network visualization, a first color for the first dealer connection and a second color for the second dealer connection.

7. The system of claim 6, wherein the computer-executable instructions to determine the first group type and the second group type further causes the at least one processor to:
determine the first dealer is subscribed to a service provided by a service provider; and
determine the second dealer is subscribed to the service.

8. A method, comprising:
receiving, by a computer comprising one or more processors, a user identifier associated with a user;
accessing vehicle transaction history associated with the user identifier;
determining, based at least in part on the vehicle transaction history, one or more vehicle transactions associated with the user identifier;
identifying one or more dealers associated with the one or more vehicle transactions;
generating a network visualization indicating respective dealer connections between the user and the one or more dealers; and
displaying the network visualization.

9. The method of claim 8, further comprising:
generating a recommendation for the user to transact with a respective dealer of the one or more dealers, wherein the recommendation is based at least in part on a number of past transactions between the user and the respective dealer.

10. The method of claim 8, further comprising:
determining that a number of indirect transactions between the user and a respective dealer of the one or more dealers is greater than or equal to a number threshold; and
generating a recommendation for the user to directly transact with the respective dealer.

11. The method of claim 8, further comprising:
receiving, from the user, one or more dealer connection parameters; and
displaying the network visualization according to the one or more dealer connection parameters.

12. The method of claim 11, wherein the one or more dealer connection parameters comprise information associated with at least one of a geographical location, a number of intervening transactions, a membership, or a vehicle.

13. The method of claim 8, further comprising:
determining a first group type associated with a first dealer of the one or more dealers and a second group type associated with a second dealer of the one or more dealer, wherein:
the first dealer is associated with a first dealer connection of the respective dealer connections with the user, and
the second dealer is associated with a second dealer connection of the respective dealer connections with the user; and
displaying, in the network visualization, a first color for the first dealer connection and a second color for the second dealer connection.

14. The method of claim 13, wherein determining the first group type and the second group type further comprises:
determining the first dealer is subscribed to a service provided by a service provider; and
determining the second dealer is subscribed to the service.

15. A non-transitory computer readable medium storing computer-executable instructions, that when executed by at least one processors, cause the at least one processor to:
receive a user identifier associated with a user;
access vehicle transaction history associated with the user identifier;
determine, based at least in part on the vehicle transaction history, one or more vehicle transactions associated with the user identifier;
identify one or more dealers associated with the one or more vehicle transactions;
generate a network visualization indicating respective dealer connections between the user and the one or more dealers; and
display the network visualization.

16. The computer readable medium of 15, wherein the computer-executable instructions further cause the at least one processor to:
generate a recommendation for the user to transact with a respective dealer of the one or more dealers, wherein the recommendation is based at least in part on a number of past transactions between the user and the respective dealer.

17. The computer readable medium of 15, wherein the computer-executable instructions further cause the at least one processor to:
determine that a number of indirect transactions between the user and a respective dealer of the one or more dealers is greater than or equal to a number threshold; and
generate a recommendation for the user to directly transact with the respective dealer.

18. The computer readable medium of 15, wherein the computer-executable instructions further cause the at least one processor to:
receive, from the user, one or more dealer connection parameters; and
display the network visualization according to the one or more dealer connection parameters.

19. The computer readable medium of 18, wherein the one or more dealer connection parameters comprise information associated with at least one of a geographical location, a number of intervening transactions, a membership, or a vehicle.

20. The computer readable medium of 15, wherein the computer-executable instructions further cause the at least one processor to:
determine a first group type associated with a first dealer of the one or more dealers and a second group type associated with a second dealer of the one or more dealer, wherein:
the first dealer is associated with a first dealer connection of the respective dealer connections with the user, and
the second dealer is associated with a second dealer connection of the respective dealer connections with the user; and
display, in the network visualization, a first color for the first dealer connection and a second color for the second dealer connection.

21. The computer readable medium of 20, wherein the computer-executable instructions to determine the first group type and the second group type further causes the at least one processor to:
determine the first dealer is subscribed to a service provided by a service provider; and
determine the second dealer is subscribed to the service.
